(19) United States
(12) Patent Application Publication
(10) Pub. No.: US 2007/0029920 A1
(43) Pub. Date: Feb. 8, 2007

(54) Display device

(76) Inventors: Osamu Shiono, Hitachi (JP); Motoyuki Miyata, Hitachinaka (JP); Yuichi Sawai, Mito (JP); Takashi Naitou, Funabashi (JP); Yoshie Kodera, Chigasaki (JP); Toshio Tojo, Chosei (JP); Masakazu Sagawa, Inagi (JP); Toshiaki Kusunoki, Tokorozawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/485,286

(22) Filed: Jul. 13, 2006

(30) Foreign Application Priority Data
Jul. 15, 2005 (JP) 2005-207116

(51) Int. Cl. H01J 63/04; H01J 1/62; H01J 9/26; H01J 9/32

(52) U.S. Cl. 313/495; 313/497; 445/25

(57) ABSTRACT

It is an object to provide a high-quality display device which prevents deterioration of color purity by use of a black matrix whose openings have sufficiently high partitions by a simple procedure.

The black matrix BM is formed using an electroconductive black glass, comprising a glass incorporated with a black additive and electroconductive filler. The glass is mainly composed of V₂O₅, SnO₂, Bi₂O₃, Ag₂O or a combination thereof.

### FIELD OF THE INVENTION

The present invention relates to a self-luminous, flat-panel display device which utilizes emission of electrons into a vacuum, in particular display device provided with a display panel comprising a rear panel and front panel, where the rear panel is composed of a rear substrate having electron sources which emit electrons by field emission, and the front panel is composed of a front substrate having a fluorescent substance excited by electrons from the rear panel to emit a different color and positive electrodes working as electron accelerator electrodes, with spacers arranged to keep a given gap between the rear and front panels (the spacer may be hereinafter referred to as gap-keeping member or partition).

### BACKGROUND OF THE INVENTION

Color cathode-ray tubes have been widely used for high-luminance, high-fineness display devices. Recently, however, demands for displays which have high-luminance, high-fineness characteristics and, at the same time, flat shapes (or flat panel type or panel type) are increasing for their light, space-saving characteristics as information processing and telecasting devices are required to produce higher-quality images.

Liquid crystal and plasma displays have been commercialized as typical examples of flat devices. Moreover, various new types of flat displays are being commercialized to produce higher-luminance images. These include devices emitting electrons or fields from an electron source into a vacuum, and organic EL displays characterized by their low power consumption. A plasma display, electron-emitting display and organic EL display which need no auxiliary illuminated light source are commonly referred to as self-luminous, flat image displays.

Of the self-luminous, flat image displays, the known field emission devices include those having a cone-shape electron emission structure, invented by C. A. Spindt et al, a metal-insulator-metal (MIM) type electron emission structure, an electron emission structure which utilizes an electron emission phenomenon by quantum tunnel effect (sometimes referred to as surface-conduction electron source), and an electron emission structure which utilizes an electron emission phenomenon activated by a diamond or graphite membrane or nano-tubes (represented by carbon nano-tubes).

A display panel which constitutes an electron emission display as one example of self-luminous, flat image displays comprises a rear panel and front panel, where the rear panel is composed of a rear substrate having, on the inner surface, electrode lines with field emission electron sources (the line is commonly referred to as cathode, signal or data line, and hereinafter referred to as signal line) and electrode lines as control electrodes (the line is commonly referred to as gate or scanning line, and hereinafter referred to as scanning line), whereas the front panel is composed of a front substrate having, on the inner surface, fluorescent substances each emitting a different color and accelerator electrodes (the electrode is referred to as anode or positive electrode), the fluorescent substance filling openings of a black matrix provided on the inner surface facing the rear panel. The front substrate which constitutes the front panel is made of an optically transparent material, for which glass is suitably used, whereas the rear substrate is made of a heat insulating material, for which glass, alumina or the like is suitably used.

The rear and front panels are bonded to each other via a sealing frame (commonly made of glass, and sometimes referred to as frame glass) extending along the inner circumferential edges, and sealed by a sealing member to form a vacuum space surrounded by these panels and frame.

The electron sources are located at near the intersections of the signal and scanning lines, a potential difference between these lines being used to control amount of electrons emitted from the sources, including on-off control of emission. The emitted electrons are accelerated by a high voltage applied to the positive electrodes in the front panel to hit the fluorescent substances also in the front panel and separated from each other by the black matrix, to excite them to emit a color characteristic of each fluorescent substance.

The individual electron source forms a unit picture cell together with the corresponding fluorescent substance. In general, a set of three unit cells each being responsible for red (R), green (G) or blue (B) color form a picture cell (referred to as color picture cell or pixel), where the unit cell is referred to as an auxiliary cell (sub-pixel).

The frame glass is secured to the rear and front panels along the inner circumferential edges by the sealing member of frit glass or the like to keep the air-tight space, surrounded by these panels and frame, vacuum at 10⁻⁵ to 10⁻⁷ torr, for example. A display panel of large display plane uses a rear and front panels secured to each other with a bonding member via spacers arranged to keep a given gap between them. The spacer is a heat insulating, plate-shape member, e.g., of glass or ceramic, coated with a film having some electroconductivity, or of a plate-shape member having some electroconductivity. Generally, one spacer is arranged for a given number of pixels at a position where it causes no interference with pixel functions.

FIG. 8 schematically illustrates one example of pixel structure for a field-emission type display device. The rear substrate SUB 1 supports, on the major plane (inner surface), the signal lines CL each serving as the lower electrode, for which an aluminum (Al) film is suitably used; first insulation film INS 1 composed of aluminum oxide film (aluminum used for the lower electrodes treated by anodic oxidation); second insulation film INS 2, for which a silicon nitride SiN film is suitably used; power supply electrodes (connection electrodes) ELC; scanning lines GL, for which chromium Cr is suitably used; and upper electrodes AED serving as the electron sources for pixels, connected to the scanning lines GL.

The electron source is composed of the signal line CL serving as the lower electrode which supports the thin film INS 3 as part of the insulation film INS 1 and upper electrode AED, in this order, where the upper electrode AED is formed in such a way to cover part of the scanning line GL and power supply electrode ELC. The thin film INS 3 is a so-called tunnel film. These members form a so-called diode electron source.

On the other hand, the front substrate SUB 2, for which a transparent glass substrate is suitably used, of the front panel PNL 2 supports, on the major plane, the fluorescent substances PH, each separated from the adjacent pixel by the black matrix BM, and positive electrodes AD, for which an aluminum film prepared by vacuum evaporation is suitably used. The positive electrode AD also works as a reflective film which directs light emitted from the fluorescent substance towards the front substrate of glass. The black matrix is normally in the form of thin film of chromium oxide or the like produced by sputtering, or of a pigment-dispersed paste produced by printing and calcining. Each opening provided in the black matrix is filled with the fluorescent substance PH. The rear panel PNL1 and front panel PNL 2 are spaced from each other by about 3 to 5 mm, the gap being kept by the spacers SPC.

In the above structure, applying an acceleration voltage (about 2.3 to 10 kV, about 5 kV specifically in FIG. 6) between the upper electrode AED for the rear panel PNL1 and positive electrode AD for the front panel PNL 2 emits the electrons e⁻, magnitude of which depends on display data size supplied to the signal line CL serving as the lower electrode. The electrons are accelerated by the acceleration voltage to hit the fluorescent layers PH, exciting them to emit the light L of given frequency to the outside of the front panel PNL 2. In the case of full-color display, the unit pixel serves as an auxiliary pixel (sub-pixel), and one color pixel is composed of three sub-pixels each being responsible for red (R), green (G) or blue (B) color.

Various studies have been made on structures with spacers for keeping a rear and front panels spaced from each other by a given gap. The structures proposed so far include those devised to prevent distortion of an electron line orbit when the spacer is charged up; to prevent loss of its partition functions by suitably arranging the spacers; and to prevent discharge. Patent Document 1 discloses one of these measures, in which fluorescent substances on the front panel on the positive electrode side project towards the electron sources to converge the electrons by keeping the electric field in a convex shape near the sources.

Patent Document 1: JP-A-2002-15686

### BRIEF SUMMARY OF THE INVENTION

A known black matrix having openings for forming fluorescent substances, each filling the opening, is of a thin-film type produced by sputtering a metal oxide, e.g., chromium oxide, or a thick-film type with patterns produced by spreading a paste containing a black pigment, e.g., graphite. Each fluorescent substance is formed after being put in each black matrix opening. When the opening wall has an insufficient height (which means the partition between the openings has an insufficient height, or the black matrix has an insufficient thickness), part of the fluorescent substance in an opening may overflow into an adjacent opening, resulting in deteriorated color purity. Therefore, the black matrix needs a sufficient thickness to form the partition which is sufficiently high to prevent contamination of the fluorescent substance.

For a black matrix of thin film type to have a sufficient thickness to work as a partition, it is necessary to repeat a film-making process to stack the films on top of another. This needs time-consuming works to form the black matrix, and larger production facilities as the panel size becomes larger, pushing up the display device production cost.

The objects of the present invention are to provide a high-quality display device which prevents deterioration of color purity by use of a black matrix whose openings have sufficiently high partitions by a simple procedure; and also to provide a method for producing the display device.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross-sectional view schematically illustrating the display device of the present invention, prepared in EXAMPLE 1, around a pixel.

FIG. 2 shows the black matrix shown in FIG. 1, views from the electron source side.

FIG. 3 compares a technique for forming the black matrix prepared in EXAMPLE 1 with a conventional technique.

FIG. 4 illustrates one example of the overall structure of the display device of the present invention.

FIG. 5 is a partly cut oblique view illustrating the overall structure of the display device of the present invention in more detail.

FIG. 6 is a cross-sectional view illustrating the display device shown in FIG. 5, cut along the line A-A′.

FIG. 7 illustrates an equivalent circuit for the display device of the present invention.

FIG. 8 schematically illustrates one example of the pixel structure for a field-emission type display device.

### DESCRIPTION OF REFERENCE NUMERALS

PNL1 Rear panel

PNL2 Front panel

SUB1 Rear substrate

SUB2 Front substrate

CL Signal line

CLT Signal line terminal

GL Scanning line

GLT Scanning line terminal

SPC Spacer

PH Fluorescent layer

BM Black matrix

AD Positive electrode

MFL Frame glass

ELS Electron source

### DETAILED DESCRIPTION OF THE INVENTION

The display device of the present invention forms a vacuum space by a front panel, rear panel, spacers and sealing frame. The front panel has a front substrate, black matrix formed on the inner surface of the substrate, fluorescent substances filling the black matrix openings and positive electrodes composed of a reflective, evaporated metal film formed over the black matrix and fluorescent substances. The rear panel has a rear substrate, signal lines formed on the inner surface of the substrate, scanning lines, insulated from the signal lines and running to intersect with the signal lines, and electron sources located at near the intersections of the insulated signal and scanning lines.

The spacers are placed between the rear and front panels to keep a given gap between these panels. The sealing frame is placed to bond the front and rear panels along the inner circumferential edges to form a vacuum space together with these panels.

The black matrix for the present invention is made of an electroconductive black glass, which may be produced by incorporating a glass with a black additive and electroconductive filler. It is mainly composed of PbO, V₂O₅, SnO₂, Bi₂O₃, Ag₂O or a combination thereof. The black additive may be of carbon black, iron oxide (Fe₃O₄), vanadium pentaoxide (V₂O₅) or rhodium black. The electroconductive filler may be of Au, Ag, Cu, Pt, Pd, Cr, Ni, Al, Si, Zn, Fe—Ni alloy, TiC, TiN, SiC, WC or MVxOy (M: Ag, Cu, Cr, Li, Sr or Ca, x: 1 to 10 and y: 2 to 30).

The black matrix of the above glass composition is lighter than a metallic film of the same thickness to bring an effect of decreasing weight of the flat display device itself, in which it is used.

The black matrix, which is formed on the front substrate, should be sufficiently adhesive. A conventional black matrix of metallic plate bonded by an adhesive agent may have the plate come unstuck. The black matrix of glass, on the other hand, is more difficult to come off than that of metallic plate, because glass is bonded to each other. Moreover, it brings another effect of producing bubbles, or uneven color on the screen caused by the bubbles, to a lesser extent than a black matrix of metallic plate bonded by an adhesive agent.

The present invention forms the black matrix by printing or photolithography. Use of the black matrix thicker than the fluorescent substance filling its openings can prevent deterioration of color purity resulting from overflow of the fluorescent substance filling one opening into an adjacent opening.

A thin metallic film is deposited by sputtering to cover the black matrix and fluorescent substances filling the matrix openings, to form positive electrodes, and aluminum can be used for the thin film.

The openings on the surface extending in parallel to the front substrate surface on which the black matrix is formed may have a varying cross-sectional shape, e.g., rectangular, oval or circle.

It is to be understood that the present invention is not limited by the structures described above and described hereinafter in the embodiments. It is needless to say that various modifications and variations can be made without departing from the technical concept of the present invention.

### EXAMPLES

The embodiments of the present invention are described by referring to the attached drawings.

### Example 1

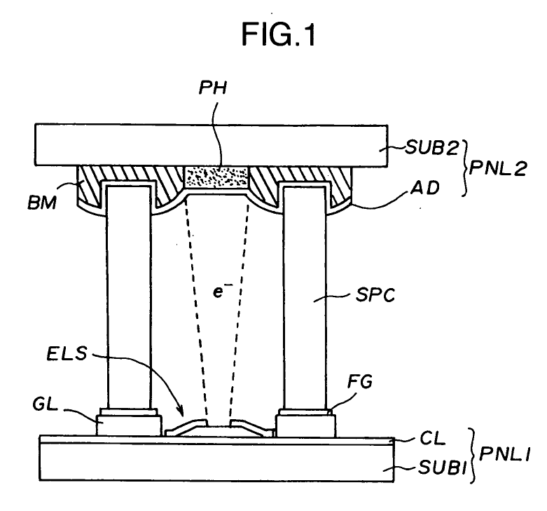

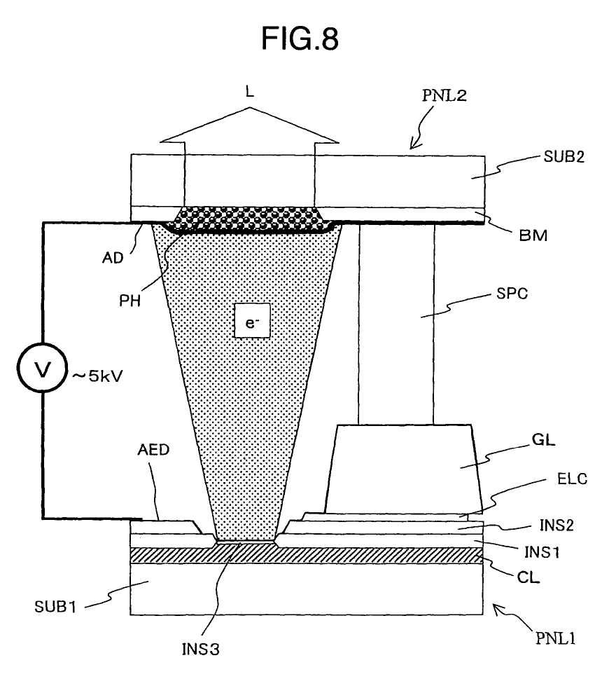

FIG. 1 is a cross-sectional view schematically illustrating the display device of the present invention, prepared in EXAMPLE 1, around a pixel. In the display device illustrated in FIG. 1, the rear substrate SUB 1 which constitutes the rear panel PNL 1 has, on the inner surface, the signal lines (data lines or cathode lines) CL and scanning lines (gate lines or gate electrode lines) GL, these lines normally intersecting each other at right angles, and the electron sources ELS located at near the intersections of these lines. The electron source ELS structure is illustrated in FIG. 8.

The front substrate SUB 2 which constitutes the front panel PNL 2 has, on the inner surface, the black matrix BM having openings filled with a fluorescent substance, where the substrate SUB 2 is made of a glass plate. The black matrix BM is formed by printing/calcinating an electroconductive black glass paste, which is composed of glass incorporated with a black additive and electroconductive filler.

The glass is mainly composed of PbO, V₂O₅, SnO₂, Bi₂O₃, Ag₂O or a combination thereof. The suitable black additives include carbon black, iron oxide (Fe₃O₄), vanadium pentaoxide (V₂O₅) and rhodium black. The electroconductive filler may be of Au, Ag, Cu, Pt, Pd, Cr, Ni, Al, Si, Zn, Fe—Ni alloy, TiC, TiN, SiC, WC or MVxOy (M: Ag, Cu, Cr, Li, Sr or Ca, x: 1 to 10 and y: 2 to 30). The black additive may be a black pigment, e.g., graphite.

Thickness of the black matrix BM, i.e., partition height between the black matrix openings, can be controlled by adjusting quantity and viscosity of the electroconductive black glass paste to be printed. It is preferably thicker than the fluorescent substance to keep a necessary quantity of the substance and prevent color contamination when it is filled in the opening. The opening shape is established when the black matrix with a number of openings is formed by screen printing, dried and preliminarily calcined to remove the solvent. The openings, after being filled with the fluorescent substances, are properly calcined together with the black matrix. Then, the black matrix is coated with a thin metal film, for which aluminum is suitably used, by sputtering to form the positive electrodes. The fluorescent substance may be filled in the opening by an ink jet method.

The electrons e⁻ from the electron sources ELS are accelerated by an acceleration voltage applied to the positive electrodes AD to hit the fluorescent substances PH, exciting them to emit the light, color of which is determined by the PH composition. The light of each color is emitted via the front substrate SUB 2 to form an image by an individual pixel. The spacers SPC shown in FIG. 1 are placed on the right and left of the pixel. This arrangement is for mere schematic illustration. In actuality, the spacers SPC are arranged on the scanning lines GL for a couple of pixels, with the ends of one side running along the scanning lines GL.

The spacers SPC are in contact with the black matrix at the ends of the other side. The spacers SPC shown in FIG. 1 are embedded in the black matrix at the ends of the other side. The figure schematically illustrates that they are partly embedded in the black matrix at the ends of the other side under an ambient pressure when the panel inside is evacuated. In actuality, the spacers SPC are fixed by an electroconductive adhesive agent (not shown) at the ends.

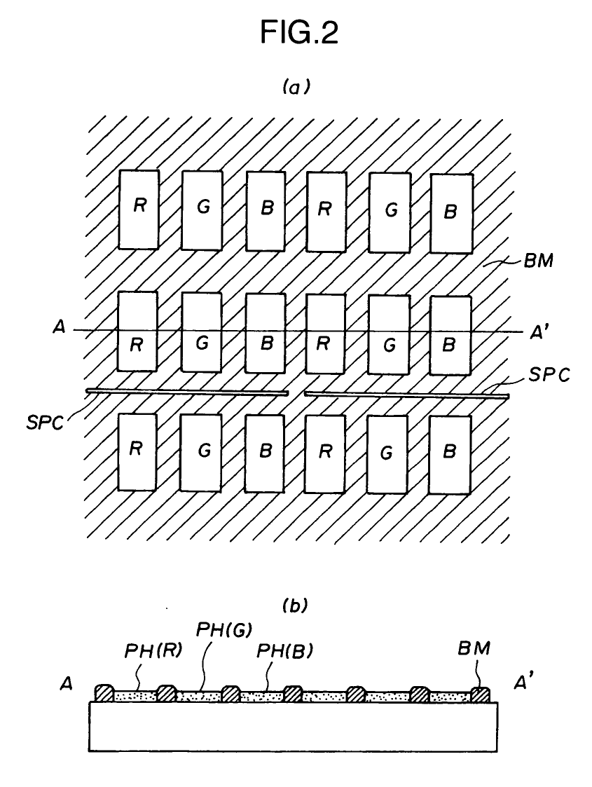

FIG. 2 is a cross-sectional view schematically illustrating the detailed structure of the display device shown in FIG. 1, viewed from the electron source side, where (a) is a plan view and (b) is a cross-sectional view along the line A-A′ shown in (a). The black matrix BM is provided with a number of openings arranged in a matrix. In FIG. 2, the rectangles “R”, “G” and. “B” represent the openings, filled with a red, green and blue fluorescent substances, respectively. The cross-sectional view shown in FIG. 2(b) illustrates that each of the openings is filled with the fluorescent substance PH(R), PH(G) or PH (B).

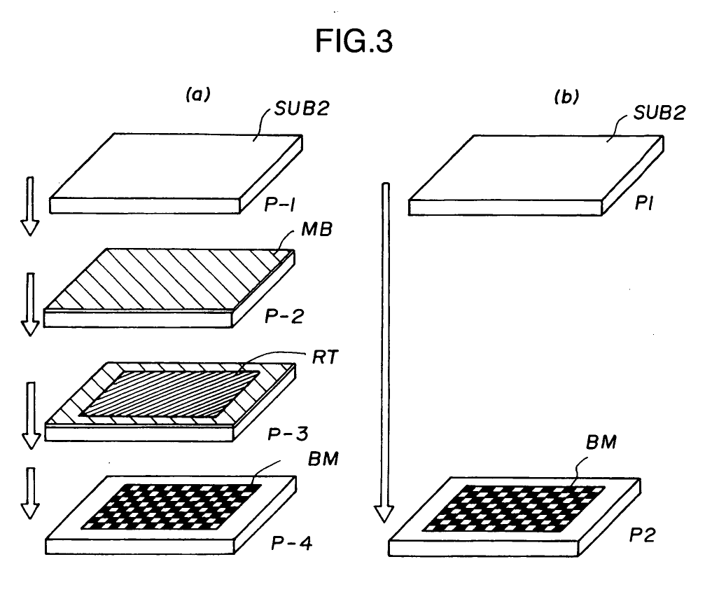

FIG. 3 compares a technique for forming the black matrix prepared in EXAMPLE 1 with a conventional technique. FIG. 3(a) illustrates a conventional thin-film making method for forming a black matrix. It first washes a glass plate for the front substrate SUB 2 and removes strains in the plate by baking (Process-1, hereinafter referred to as P-1). Then, the glass plate inner surface is coated with a thin film of chromium oxide-chromium (CrO—Cr) by sputtering (P-2). Thickness of the thin film formed by one sputtering step is insufficient, and the sputtering steps are repeated until the film having a thickness sufficient for assuring a given partition height is obtained. When formed to have a necessary thickness, the thin film is coated with a photosensitive resist, and then treated by exposure/development via an exposure mask to remove the photosensitive resist on the openings (P-3). Then, it is etched to remove the thin film and residual photosensitive resist on the openings (P-4). This produces the black matrix provided with the openings.

On the other hand, the method adopted in Example 1 for the present invention, illustrated in FIG. 3(b), washes a glass plate for the front substrate SUB 2 and removes strains in the plate by baking (P-1). Then, the black matrix BM opening patterns are formed with the glass paste described above by screen printing, dried and preliminarily calcined to produce the black matrix BM provided with the openings.

As described above, the production method of the present invention can easily produce the black matrix provided with the openings having a necessary thickness by a smaller number of processes than the conventional one. Therefore, it needs less expensive production systems and can reduce the production cost.

The printing described above may be replaced by photolithography which produces the black matrix BM provided with the openings arranged in a matrix by coating the inner front substrate surface with a photosensitive resist and paste, which are then subjected to preliminary calcination, exposure/development via a mask, removal of the resist, calcination and etching. The photolithography, also spreading the paste to form a thick film, can form sufficiently high partitions to prevent the fluorescent substance filling an opening from overflowing into an adjacent opening.

The black glass composed of vanadium or lead as the main component for the present invention allows for faster etching than a glass composed of silicon as the main component generally used for substrates. Therefore, use of the black glass in combination of a glass composed of silicon as the main component for the substrate substantially prevents etching from reaching the substrate while the openings are being formed, and is expected to improve production yield of the black matrix.

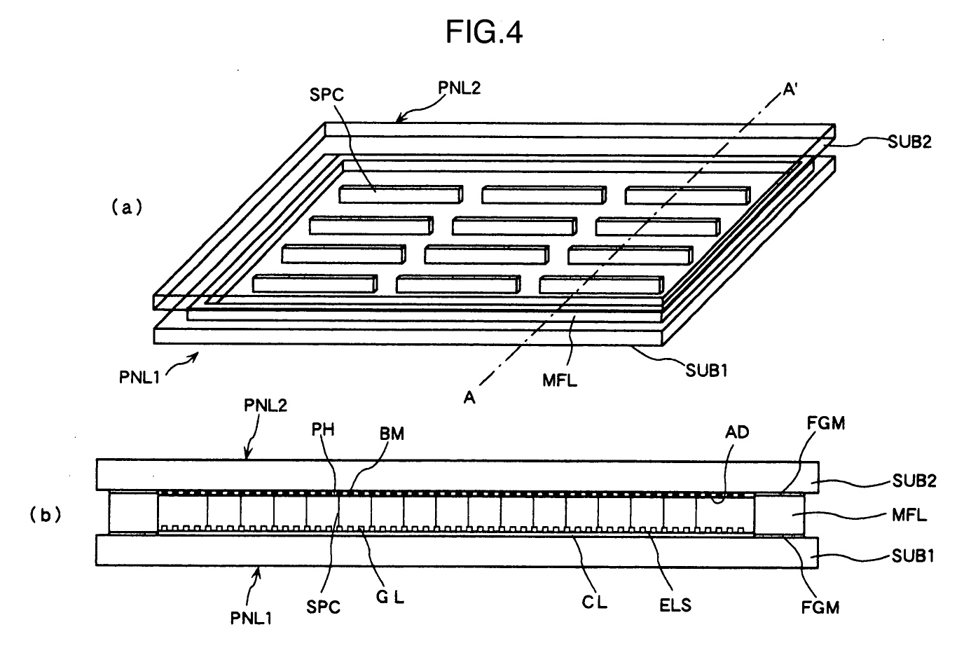

FIG. 4 illustrates one example of the overall structure of the display device of the present invention, where (a) is an oblique view and (b) is a cross-sectional view outlining the device along the line A-A′ shown in (a). In the display shown in FIG. 4, the rear substrate SUB 1 which constitutes the rear panel PNL 1 has the signal lines (data or cathode lines) CL and scanning lines (gate electrode lines) GL on the inner surface, and electron sources ELS located at the intersections of these lines, as described above. Each of these lines is connected to an interconnection at the terminal (not shown), as described above.

The front substrate SUB 2 which constitutes the front panel PNL 2 has, on the inner surface, the black matrix BM, positive electrodes AD and fluorescent substances PH, among others. The rear and front substrates SUB 1 and SUB 2, which constitute the respective rear and front panels PNL 1 and PNL 2, are bonded to each other by the sealing member FGM via the sealing frame MFL extending along the inner circumferential edges. The spacers SPC are arranged between the rear substrate SUB 1 and front substrate PNL 2 to keep a given gap between these panels bonded to each other.

The inner space sealed by the rear panel PNL 1, front panel PNL 2 and sealing frame MFL is evacuated through a discharge nozzle (not shown) provided on the rear panel PNL 1 to be kept at a given degree of vacuum.

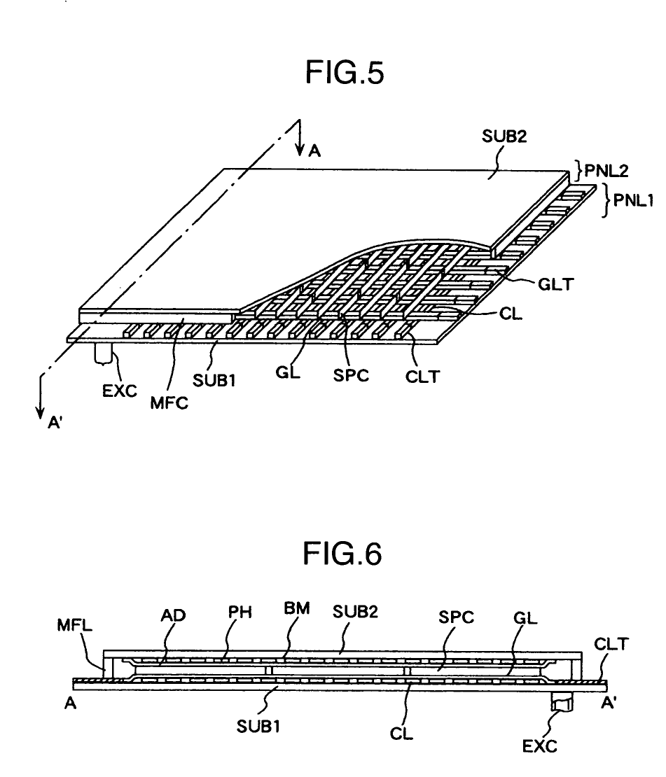

FIG. 5 is a partly cut oblique view illustrating the overall structure of one embodiment of the display device of the present invention in more detail. FIG. 6 is a cross-sectional view illustrating the display device shown in FIG. 5 along the line A-A′. To repeat the illustration, the substrate SUB 1 which constitutes the rear panel PNL 1 has, on the inner surface, the signal lines CL, scanning lines GL and electron sources at near the intersections of these lines. Each of the electrode line CL and scanning line GL is connected to the interconnection CLT at the terminal.

As described above, the front substrate SUB 2 which constitutes the front panel PNL 2 has, on the inner surface, the black matrix BM, positive electrodes AD and fluorescent substances PH. The rear and front substrates SUB 1 and SUB 2, which constitute the respective rear and front panels PNL 1 and PNL 2, are bonded to each other via the sealing frame MFL extending along the inner circumferential edges. The spacers SPC, for which a glass or ceramic plate is suitably used, are arranged between the rear substrate SUB 1 and front substrate PNL 2 to keep a given gap between these panels bonded to each other. FIG. 6 is a cross-sectional view illustrating the display device shown in FIG. 5 along the spacers SPC. FIG. 6 shows the 3 spacers SPC on the scanning line GL, but this structure represents only one example.

The inner space sealed by the rear panel PNL 1, front panel PNL 2 and sealing frame MFL is evacuated through a discharge nozzle EXC provided on the rear panel PNL 1 to be kept at a given degree of vacuum, as described above.

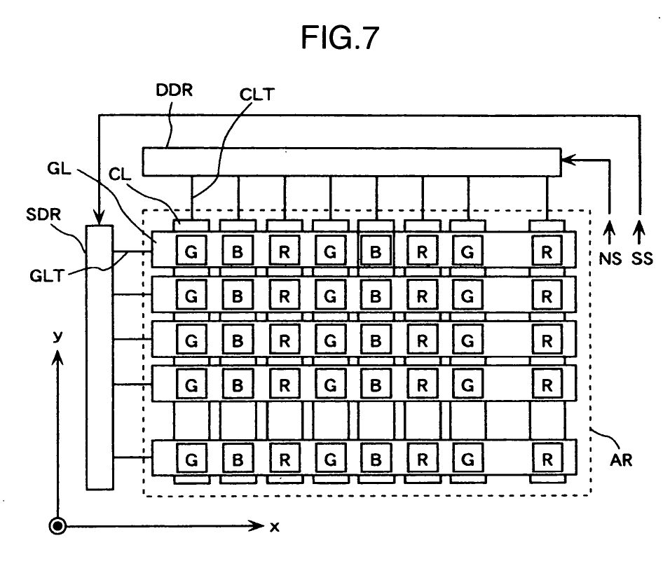

FIG. 7 illustrates an equivalent circuit for the display device of the present invention. The area surrounded by the broken lines represents the display area AR, where the signal lines CL (n-lines) and scanning lines (m-lines) intersect with each other to form an n×m matrix. A color sub-pixel is formed at near the intersection in the matrix. A set of the 3 sub-pixels “R,” “G” and “B” shown in FIG. 6 constitutes one color pixel. The signal lines CL are connected to the image signal driving circuit DDR at the terminals CLT, and the scanning lines GL are connected to the scanning signal driving circuit SDR at the terminals GLT. The image signal driving circuit DDR receives the image signal NS from an outside signal source, and the scanning signal driving circuit SDR similarly receives the scanning signal SS.

A two-dimensional, full-color image can be displayed by supplying an image signal to the signal lines CL intersecting with the scanning lines GL selected one by one. Use of the display panel of the above structure can realize a self-luminous, flat display working efficiently at a relatively low voltage.

The spacer SPC is a formed shape of a glass containing SiO₂ as the main component and at least one element selected from the group consisting of La, Sc, Y, Ce, Pr, Nd, Pm, Sm, Eu, Gd, Tb, Dy, Ho, Er, Tm, Yb and Lu at 1 to 20% by mass. The spacer body is coated with an electroconductive film for antistatic purposes. The spacer body itself may be made of an electroconductive material instead of being coated with an electroconductive film for antistatic purposes.

The spacers SPC are arranged in the display area AR formed between the rear substrate SUB 1 and front substrate SUB 2 almost at right angles to these substrates, in such a way that they are lined up in parallel to each other in the length direction (x-direction in FIG. 7) at given intervals, and also in another direction (y-direction in FIG. 7) intersecting with the x-direction to run on the scanning lines GL at given intervals, and bonded and fixed by an adhesive agent, for which an electroconductive bonding member is suitably used.

The electroconductive bonding member contains a composition of MVxOy (M: Ag, Cu, Cr, Li, Sr or Ca, x: 1 to 10 and y: 2 to 30). The composition MVxOy may be an electroconductive glass composition for the present invention, which is a lead-free, low-melting glass, for which AgV₇O₁₈ and Ag₂V₄O₁₁ are suitably used. The bonding member is produced by kneading the electroconductive glass composition incorporated with AgV₇O₁₈ and Ag₂V₄O₁₁ particles in the presence of an adequate binder.

The present invention is described by taking a structure with an MIM type electron source as an example. However, it is needless to say that various types of electron sources described above can be used for the self-luminous image display.

It should be further understood by those skilled in the art that although the foregoing description has been made on embodiments of the invention, the invention is not limited thereto and various changes and modifications may be made without departing from the spirit of the invention and the scope of the appended claims

### ADVANTAGES OF THE INVENTION

The present invention provides a high-quality display device of high color purity, provided with a black matrix whose openings have sufficiently high partitions formed by a simple procedure.

1. A display device comprising:
a front panel having: a front substrate; a black matrix formed on an inner surface of the front substrate and provided with a number of openings arranged in a matrix; fluorescent substances filling the openings; and positive electrodes composed of a reflective evaporated metal film formed over the black matrix and fluorescent substances;
a rear panel having: a rear substrate; signal lines; scanning lines insulated from the signal lines and running to intersect with the signal lines; and electron sources located at near the intersections of the signal and scanning lines, these lines and electron sources being formed on the inner surface of the substrate;
spacers placed between the rear and front panels, which are bonded to each other, to keep a given gap between these panels; and
a sealing frame placed along the inner circumferential edges of the front and rear panels bonded to each other to form a vacuum space together with these panels, wherein
the black matrix is made of an electroconductive black glass.

2. The display device according to claim 1, wherein the electroconductive black glass is of a mixture of a glass, black additive and electroconductive filler.

3. The display device according to claim 2, wherein the glass is composed of PbO, V₂O₅, SnO₂, Bi₂O₃, Ag₂O or a combination thereof as the main component.

4. The display device according to claim 2, wherein the black additive is carbon black, iron oxide (Fe₃O₄), vanadium pentaoxide (V₂O₅) or rhodium black.

5. The display device according to claim 2, wherein the electroconductive filler is of Au, Ag, Cu, Pt, Pd, Cr, Ni, Al, Si, Zn, Fe—Ni alloy, TiC, TiN, SiC, WC or MVxOy (M: Ag, Cu, Cr, Li, Sr or Ca, x: 1 to 10 and y: 2 to 30).

6. The display device according to claim 1, wherein the black matrix is formed by printing or photolithography.

7. The display device according to claim 1, wherein the black matrix is thicker than the fluorescent substance.

8. A method for producing a display device comprising a front panel having a black matrix formed on an inner surface of a front substrate and provided with a number of openings arranged in a matrix, fluorescent substances filling the openings, and positive electrodes composed of a reflective evaporated metal film formed over the black matrix and fluorescent substances,
which method comprises:
forming the black matrix provided with a number of openings by screen printing or photolithography;
filling the openings with the fluorescent substances; and
calcining the black matrix together with the openings,
wherein the black matrix is formed to be thicker than the fluorescent substance.

9. The method for producing a display device according to claim 8, wherein a thin metal film is formed by sputtering to form the positive electrodes after the calcination process.

10. The method for producing a display device according to claim 9, wherein the thin metal film is of aluminum.
